(19) United States
(12) Patent Application Publication
(10) Pub. No.: US 2024/0346456 A1
(43) Pub. Date: Oct. 17, 2024

(54) Intelligent Schedules

(71) Applicant: Hewlett-Packard Development Company, L.P., Spring, TX (US)

(72) Inventor: Gaurav Roy, Spring, TX (US)

(73) Assignee: Hewlett-Packard Development Company, L.P., Spring, TX (US)

(21) Appl. No.: 18/291,830

(22) PCT Filed: Aug. 30, 2021
(86) PCT No.: PCT/US2021/048298

§ 371 Date: Jan. 24, 2024

(51) Int. Cl. G06Q 10/1093; G06Q 10/0639

(52) U.S. Cl. CPC G06Q 10/1097; G06Q 10/06393

(57) ABSTRACT

In some examples, a computer-readable medium stores instructions. When executed by a processor, the instructions cause the processor to execute an intelligent scheduling application to capture, via the intelligent scheduling application, processor data of a computing device indicating usage statistics of a user using the computing device, analyze the usage statistics to determine a usage pattern of the user, analyze calendar data of the user, and based on the usage pattern of the user and the calendar data, modify scheduling of an event included in the calendar data.

### BACKGROUND

Research indicates that a relationship may exist between increased stress and decreased productivity. Causes of such increased stress may include a decrease in break time between calendared activities, meetings, times of focused work, etc.

### BRIEF DESCRIPTION OF THE DRAWINGS

Various examples will be described below referring to the following figures.

FIG. 1 is a flowchart of a method for intelligent scheduling in accordance with various examples.

FIG. 2 is a diagram of a computer-readable medium storing intelligent scheduling executable code in accordance with various examples.

FIG. 3 is a diagram of a computer-readable medium storing intelligent scheduling executable code in accordance with various examples.

FIG. 4 is a diagram of a computer-readable medium storing intelligent scheduling executable code in accordance with various examples.

FIG. 5 is a block diagram of a computing device in accordance with various examples.

### DETAILED DESCRIPTION

This disclosure describes an intelligent scheduling process in which employee activity data is analyzed to classify the activity and draw insights from the activity. The activity data may be determined based on an application executing on an employee device which reports information about an active application on the employee device, inputs provided to the employee device, data in a calendar of the user, etc. Patterns of stress may be determined based on the activity and compared to crowdsourced activity data. For example, activity for a particular user may be compared to all users in a same organizational group as the particular user. In another example, activity for a particular organizational group may be compared to other organizational groups or an organization as a whole.

Based on the comparisons, recommendations may be provided and/or actions may be taken. For example, a recommendation may be provided to the particular user to schedule a break from working at a particular point during a period of time of work. In another example, a recommendation may be provided at an organizational group, or organization, level to modify work activity scheduling for the organizational group or the organization. Based on the comparisons, actions may also be taken. For example, an intelligent scheduling application may cancel or reschedule events in a calendar of the particular user to facilitate the particular user taking breaks from working. The intelligent scheduling application may indicate acceptable times to schedule work related events at an organizational group level, or an organization level, times at which work related events should not occur, scheduled organizational group level, or organization level, breaks from work related events, etc. In some examples, the intelligent scheduling application may coordinate across calendars of multiple users to reschedule events to facilitate breaks for some of the users.

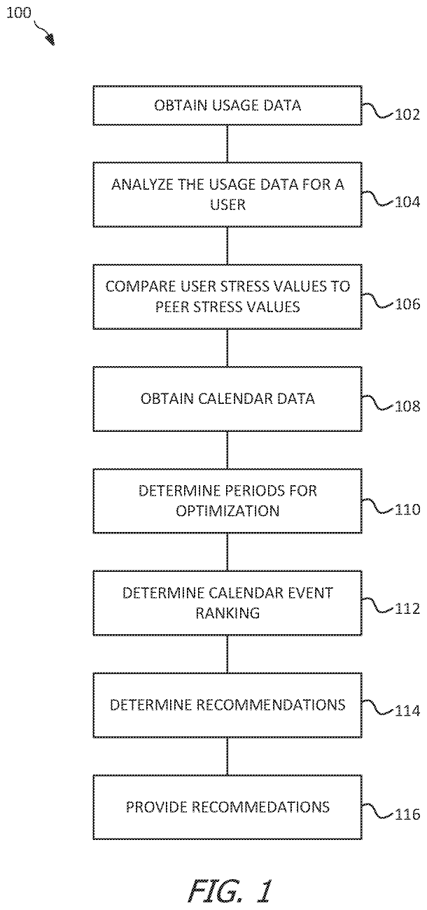

FIG. 1 shows a flowchart of a method 100 in accordance with various examples. In some examples, the method 100 is a method for determining a recommendation based on usage data and calendar data, such as to perform intelligent scheduling.

In some examples, the recommendation is a calendar optimization recommendation. The calendar optimization recommendation may be a recommendation to reschedule a scheduled event or to not schedule an event in a given time period for which an event is not scheduled at a time the recommendation is provided.

At operation 102, usage data is obtained. In some examples, the usage data is obtained from a data store, such as a usage data store. In other examples, the usage data is received is received from user devices. The usage data may be usage data of user devices, such as activity data of the users (e.g., data related to what applications are being used at what time on a device, a level of engagement with the device at a given time, etc.), processor data of the device (e.g., what tasks are executing via a processor at a given time, an amount of processing capability dedicated to a particular task at a given time or for a given amount of time, etc.), or any other usage data that indicates usage characteristics of the device by users.

In some examples, the usage data includes a device screen on time that indicates an amount of time that a user device is active and the screen of the user device is unlocked. As used herein, a user device may be deemed active if the screen of the user device is unlocked and turned on and a last action involving the user device (e.g., input received from user, output such as audio or video provided to user, etc.) has occurred within a programmed time frame. In some examples, the programmed time frame is about one minute. The usage data may also include a device user active time that indicates an amount of time that the user is interacting with the user device (e.g., moving a mouse, typing on a keyboard, interacting with a conference call via the microphone, speakers, and/or camera, etc.). The usage data may also include a collaboration time that indicates an amount of time that the user is active in a collaborative event, such as a video conference, meeting application, or other collaborative event with another user. The usage data may also include a productivity time that indicates an amount of time that the user is interactive with productivity applications via the user device. For example, the productivity time may indicate an amount of time that a productivity application is forefront or in focus on a display of the user device. Whether an application is deemed a productivity application may vary from one type of user to another type of user, from one user group to another user group, and from one industry to another industry. The usage data may also include cohort data that may indicate a type of the user (e.g., what role the user is assigned within an organization or to which group of users the user belongs, such as engineering, sales, user experience, customer service, etc.).

At operation 104, the usage data is analyzed at a personal level for the user. Operation 104 may be repeated for multiple users for which usage data was obtained at operation 102. In some examples, the various data points included in the usage data are associated with stress values. For example, a particular application or event is associated with a particular stress values per unit of time for which the user is interacting with that application or event. For example, a user interacting with an email application may be associated with an increase in stress of 10 units per minute. A user interacting with a conference or collaboration application may be associated with an increase in stress of 25 units per minute. A user taking a break from work may be associated with a decrease in stress of 30 unites per minute. Interacting with various other applications or taking part in various other events may be associated with other increases or decreases in stress of an suitable amount.

Based on the stress values and the usage data, stress levels of the user are determined per period of time. A rolling sum may be calculated for the stress levels, where the rolling sum is a sum of the stress value for a given activity multiplied by an amount of time that the user was engaged in the activity. Based on the determined stress levels per period of time, an average stress per unit of time may be determined. In some examples, the unit of time is ten minutes. In other examples, the unit of time is another suitable time, such as six minutes, fifteen minutes, twenty minutes, thirty minutes, etc.

Based on the determined average stress per unit of time, high stress periods are determined. A high stress period may be defined as a unit of time for which the determined average stress exceeds a threshold. In some examples, the threshold is 500. In other examples, the threshold is any suitable value. A sum of high stress minutes per day for the user may be determined based on a number of units of time for which the determined average stress exceeds the threshold. An average stress level of the user for a day may be determined based on an average of the determined average stress per unit of time for each unit of time in a workday of the user. In some examples, the average stress level of the user for the day may be determined according to a median of the determined average stress per unit of time values. For example, the determined average stress per unit of time values may have outlying data points, such as if the user was involved in a particularly high-stress event for short period of time in an otherwise low-stress day. Thus, determining the average stress level of the user for the day according to the median of the determined average stress per unit of time values may, in some circumstances, provide a more accurate representation of the average stress level of the user for the day than other methods of determining an average. In other examples, the average stress level of the user for the day may be determined according to a mean of the determined average stress per unit of time values.

At operation 106, determined stress values for the user are compared against peer stress values. A peer stress value may be a value determined as described above for a cohort or coworker of the user, such as another user determined to belong to a same user group as the user. In some examples, the user group is defined as other users within a same organization having a same or similar job title, a same role within the organization (e.g., engineering, sales, user experience, customer service), other users with a same sub-unit of the organization regardless of role, a same role across multiple organizations for which usage data is available, etc.

In some examples, the user groups may be determined, wholly or in part, according to K-means clustering, where the clustering is performed according to applications or events with which the users interact or in which the users take part. In some examples, the K-means clustering may create user groups that define groups of users who interact with similar applications for the longest periods of time among the users.

Based on the determined user groups, a comparison may be determined between the determined values for the user and the peer values. For example, a comparison of high stress minutes per day, average stress level of the user for the day, or average stress per unit of time may be determined. In some examples, the comparison may be multi-factor. For example, the user may be determined to have a particular percentage of the average stress level per day of the user's peers with a given amount of high stress minutes per day.

At operation 108, calendar data is obtained. The calendar data may include scheduling data showing start and end times of calendared events for the user. In some examples, the calendar data may also include scheduling data showing start and end times of calendared events for the user's peers. The calendared events may be work related (e.g., meetings, teleconferences, videoconferences, etc.) or non-work related (e.g., scheduled breaks, errands, etc.).

At operation 110, periods for optimization may be determined based on the calendar data and the determined stress values. For example, times of determined, or estimated, high stress or excessive buildup of stress may be identified. Based on the determined times of high stress or excessive build up of stress, calendared events may be identified for rescheduling to reduce times of high stress or excessive buildup of stress. Based on the determined times of high stress or excessive buildup of stress, times not having calendared events may be identified for reserving for breaks to reduce stress.

At operation 112, calendared events coinciding with the periods for optimization may be analyzed to determine rankings of the calendared events coinciding with the periods for optimization. For example, calendared events occurring during high stress periods of time, or times at which a excessive buildup of stress may occur, may be analyzed to determine their rankings. The rankings may provide weightings to the calendared events, where weights increase from low to high as rescheduling difficulty increases. Rescheduling difficulty may be determined based on a number of participants in a calendared event, a calendar event density for the participants, etc. In some examples, the calendar event density is determined as a percentage of time for which a participant has calendared activities in a programmed amount of time. In some examples, the programmed amount of time is about two to about four hour blocks of time. In an example, the determined weight for a calendared event may be a sum of calendar event densities for all scheduled participants in the calendared event.

At operation 114, based on the determined rankings, recommendations may be determined. For example, the calendar data of each scheduled participant in a meeting may be analyzed and a recommendation may be determined for rescheduling some of the calendared events coinciding with the periods for optimization. For example, the calendar data of each scheduled participant in a calendared event may be analyzed to determine a mutually free time for the calendared event to be rescheduled into. In some examples, the recommendation may be determined so as to not create a new high stress time for more than a threshold number of scheduled participants in the calendared event or to decrease at least one stress value for a threshold number of the scheduled participants in the calendared event.

At operation 116, the recommendations may be provided to the users. In some examples, the recommendations are provided to the user through a graphical user interface. The recommendations may be presented with some of the usage data, calendar data, stress level values, average stress levels, or any other suitable data obtained, or determined, according to the teachings herein. In some examples, providing the recommendations includes presenting a recommendation to reschedule a calendared event to a different time. Alternative times for the calendared event may be presented with the recommendation. In some examples, providing the recommendations includes presenting a recommendation to schedule a break period at a particular time. In some examples, providing the recommendations to the users includes automatically rescheduling a calendared event of some of the users without intervention of the some of the users. In some examples, providing the recommendations to the users includes scheduling break periods into the calendar data of some of the users without intervention of the some of the users. In some examples, providing the recommendations to the users includes providing a recommendation to a management entity to modify organizational policies with respect to scheduling calendared events or scheduling break periods according to stress levels.

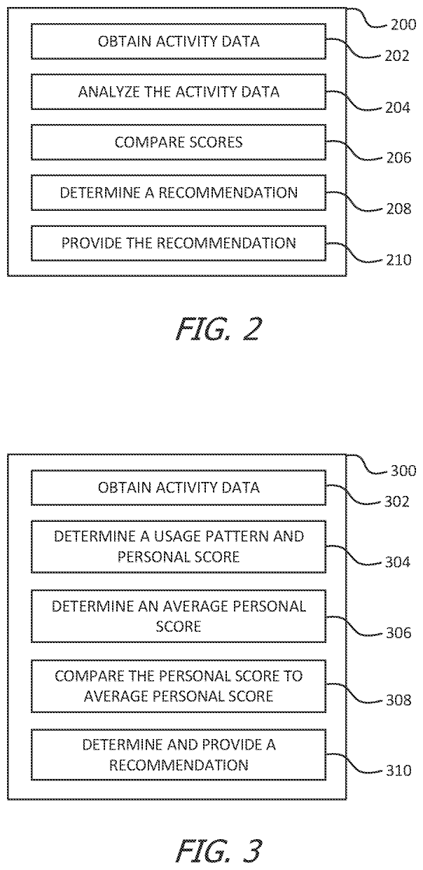

FIG. 2 is a diagram of a computer-readable medium 200 storing executable code in accordance with various examples. In some examples, the computer-readable medium 200 is non-transitory in nature and the executable code is machine-executable. When executed by a processor, the executable code causes the processor to perform functions or operations. In some examples, the executable code is representable as instructions or a computer program product, such as an intelligent scheduling application. In some examples, the executable code may cause the processor to perform functions associated with intelligent scheduling, as described in this disclosure.

In some examples, instruction 202 causes the processor to obtain activity data of a user indicating usage statistics of a computing device by the user. The activity data may be received from any suitable device, such as the computing device or a data store. The activity data may include data related to what applications are being used at what time on the computing device, a level of engagement with the computing device at a given time, etc. The activity data may also include processor data of the computing device (e.g., what tasks are executing via a processor at a given time, an amount of processing capability dedicated to a particular task at a given time or for a given amount of time, etc.). The activity data may also include any other data that indicates usage characteristics of the computing device by users.

In some examples, instruction 204 causes the processor to analyze the activity data of the user to determine a personal score of the user. In some examples, the analysis attributes programmed stress values according to application usage indicated in the activity data, to periods of time. Based on determined stress values for the periods of time, an amount of high stress time and average stress values may be determined. In some examples, the personal score includes the amount of high stress time or an average stress value.

In some examples, instruction 206 causes the processor to compare the personal score of the user to a target score and scores of peers of the user to determine a comparison result. In some examples, the target score is specified by an organization to which the user belongs, and is a value such as a maximum value for the amount of high stress time, a maximum average stress value, a maximum value for built-up, or cumulative, stress during a day, a maximum value for built-up, or cumulative, stress during week or other time period, etc. The comparison may result in the determination of a comparison result that indicates a stress level of the user with respect to the target score or the scores of the peers of the user.

In some examples, instruction 208 causes the processor to, based on the comparison result, determine a recommendation for the user. For example, based on the user having a personal score greater than a threshold amount of the average score of the peers of the user, or greater than the target score, a recommendation to reduce the stress level of the user may be determined. The recommendation may include rescheduling calendared events or scheduling break periods, as described above.

In some examples, instruction 210 causes the processor to provide the recommendation to the user via a graphical interface. In some examples, the recommendation is shown as a list of times in which break periods are recommended. In some examples, the recommendation is a list of calendared events to reschedule. The list may include a second list of recommended times that are available into which the calendared events may be rescheduled. In some examples, some of the recommended actions may be performed automatically without user intervention and the user may be notified of the change resulting from the determination of the recommendation.

In some examples, the graphical user interface may include other data. The other data may include various data collected for use in determining the stress levels, such as collected according to instruction 202, as described above. The other data may also include various data determined according to the data collected according to instruction 202, such as determined stress levels, comparison results, etc.

FIG. 3 is a diagram of a computer-readable medium 300 storing executable code in accordance with various examples. In some examples, the computer-readable medium 300 is non-transitory in nature and the executable code is machine-executable. When executed by a processor, the executable code causes the processor to perform functions or operations. In some examples, the executable code is representable as instructions or a computer program product, such as an intelligent scheduling application. In some examples, the executable code may cause the processor to perform functions associated with intelligent scheduling, as described in this disclosure.

In some examples, instruction 302 causes the processor to obtain activity data of a group of users. The activity data may be received from any suitable devices, such as computing devices or a data store. The activity data may include data related to what applications are being used at what time on the computing devices, a level of engagement with the computing devices at a given time, etc. The activity data may also include processor data of the computing devices (e.g., what tasks are executing via processors at a given time, an amount of processing capability dedicated to a particular task at a given time or for a given amount of time, etc.). The activity data may also include any other data that indicates usage characteristics of the computing devices by the users.

In some examples, instruction 304 causes the processor to, for each user of the group of users, determine a usage pattern based on the activity data and determine a personal score based on the usage pattern. The usage pattern may indicate an amount of time that is spent by each respective user interacting with, or using, each application indicated in the activity data. A stress value may be attributed to each application for a period of time, as described above. The personal score may be determined based on the stress values. For example, the personal score may indicate an amount of high stress time during a period of time, an average stress during a period of time, etc.

In some examples, instruction 306 causes the processor to determine an average personal score for the group of users based on the personal score for each user. The average score may be determined as a mean, a median, or any other suitable averaging methodology.

In some examples, instruction 308 causes the processor to compare the personal score of a user of the group of users to the average personal score to determine a comparison result. The comparison result may indicate whether the user is less stressed or more stressed than an average of the user's peers, as described above herein.

In some examples, instruction 310 causes the processor to, based on the comparison result, determine and provide a recommendation to the user. For example, based on the user having a personal score greater than a threshold amount of the average score of the peers of the user a recommendation to reduce the stress level of the user may be determined. The recommendation may include rescheduling calendared events or scheduling break periods, as described above. In some examples, the recommendation is provided as a list of times in which break periods are recommended. In some examples, the recommendation is provided as a list of calendared events to reschedule. The list may include a second list of recommended times that are available into which the calendared events may be rescheduled. In some examples, some of the recommended actions may be performed automatically without user intervention and the user may be notified of the change resulting from the determination of the recommendation.

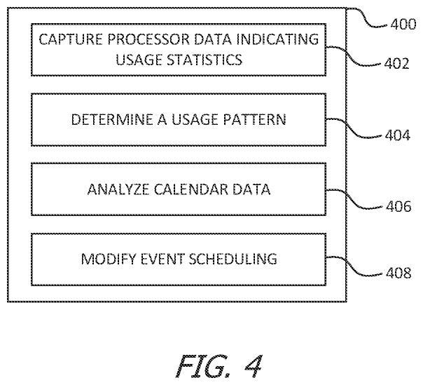

FIG. 4 is a diagram of a computer-readable medium 400 storing executable code in accordance with various examples. In some examples, the computer-readable medium 400 is non-transitory in nature and the executable code is machine-executable. When executed by a processor, the executable code causes the processor to perform functions or operations. In some examples, the executable code is representable as instructions or a computer program product, such as an intelligent scheduling application. In some examples, the executable code may cause the processor to perform functions associated with intelligent scheduling, as described in this disclosure.

In some examples, instruction 402 causes the processor to capture, via the intelligent scheduling application, processor data of a computing device indicating usage statistics of a user using the computing device. The usage statistics may include data related to what applications are being used at what time on the computing device, a level of engagement with the computing devices at a given time, etc. The usage statistics may also include data of the computing device indicating what tasks are executing via processors at a given time, an amount of processing capability dedicated to a particular task at a given time or for a given amount of time, etc. The usage statistics may also include any other data that indicates usage characteristics of the computing device by the user.

In some examples, instruction 404 causes the processor to analyze the usage statistics to determine a usage pattern of the user. The usage pattern may indicate an amount of time that is spent by the user interacting with, or using, each application indicated in the usage statistics. A stress value may be attributed to each application for a period of time, as described above. A personal score may be determined based on the stress values. For example, the personal score may indicate an amount of high stress time during a period of time, an average stress during a period of time, etc.

In some examples, instruction 406 causes the processor to analyze calendar data of the user. For example, the calendar data may be analyzed to determine calendared events that may be optimized, such as by allocating unoccupied calendar time for break periods or by rescheduling a calendared activity.

In some examples, instruction 408 causes the processor to, based on the usage pattern of the user and the calendar data, modify scheduling of an event included in the calendar data. For example, the scheduling of the event included in the calendar data may be modified to reduce an amount of high stress time of the user, reduce an average stress of the user, or decrease any other suitable stress related parameter or value of the user.

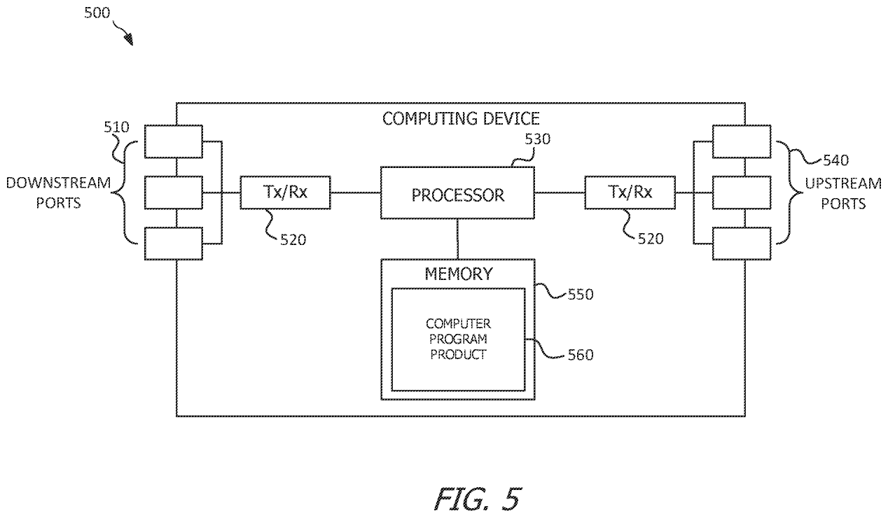

FIG. 5 is a block diagram of a computing device 500 in accordance with various examples. Computing device 500 may be any device capable of performing the functions disclosed herein, such as a server, a laptop computer, a notebook computer, a netbook computer, a tablet computer, a smartphone, a desktop computer, an all-in-one computer, a conference device (e.g., teleconference or videoconference), etc. Computing device 500 is to implement some of the features/methods disclosed herein, for example, as described above with respect to FIG. 1, FIG. 2, FIG. 3, and/or FIG. 4. In various examples, for instance, the features/methods of this disclosure are implemented using hardware or executable code installed to run on hardware.

Computing device 500 is a device (e.g., an access point, an access point station, a router, a switch, a gateway, a bridge, a server, a client, a user-equipment, a mobile communications device, etc.) that transports data through a network, system, and/or domain, and/or provides services to other devices in a network or performs computational functions. In one example, the computing device 500 is an apparatus and/or system to implement the intelligent scheduling of this disclosure, for example according to a computer program product.

The computing device 500 comprises downstream ports 510 coupled to a transceiver (Tx/Rx) 520, which is a transmitter, receiver, or combination thereof. The Tx/Rx 520 transmits and/or receives data from other devices via the downstream ports 510. Similarly, the computing device 500 comprises another Tx/Rx 520 coupled to a plurality of upstream ports 540, wherein the Tx/Rx 520 transmits and/or receives data from other computing devices via the upstream ports 540. The downstream ports 510 and/or the upstream ports 540 may include electrical and/or optical transmitting and/or receiving components. In another example, the computing device 500 comprises antennas (not shown) coupled to the Tx/Rx 520. The Tx/Rx 520 may transmit and/or receive data from other computing or storage devices wirelessly via the antennas.

A processor 530 is coupled to the Tx/Rx 520 and is to perform, among other functions, intelligent scheduling according to the various examples of this disclosure. In an example, the processor 530 comprises multi-core processors and/or memories 550, which function as data stores, buffers, etc. The processor 530 may be implemented as a general processor or as part of application specific integrated circuits (ASICs), field-programmable gate arrays (FPGAs), and/or digital signal processors (DSPs). Although illustrated as a single processor, the processor 530 is not so limited and alternatively may be implemented as multiple processors. The processor 530 further includes processing logic to execute a computer program product 560 that is to perform intelligent scheduling according to the various examples of this disclosure.

FIG. 5 also illustrates that a memory 550 is coupled to the processor 530 and is a non-transitory medium to store various types of data. The term “non-transitory” as used herein does not encompass transitory propagating signals. Memory 550 comprises memory devices including secondary storage, read-only memory (ROM), and random-access memory (RAM). The secondary storage comprises disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that may have a small memory capacity relative to the larger memory capacity of the secondary storage. The RAM is used to store volatile data and perhaps to store instructions. Access to both the ROM and RAM may be faster than to the secondary storage.

The memory 550 may be used to house the instructions for carrying out the various examples described herein. For example, the memory 550 may comprise the computer program product 560, which is executed according by processor 530. In various examples, the computer program product 560 may include machine executable instructions for performing the functions described above with respect to the method 100, the computer-readable medium 200, the computer-readable medium 300, and/or the computer-readable medium 400.

By programming and/or loading executable instructions onto the computing device 500, one of the processor 530 and/or the memory 550 are changed, transforming the computing device 500 in part into a particular machine or apparatus, for example, an intelligent scheduling device having the functionality taught by this disclosure. Functionality that can be implemented by loading executable code into a computer can be converted to a hardware implementation according to design rules. Decisions between implementing a concept in executable code versus hardware may hinge on considerations of stability of the design and number of units to be produced rather than any issues involved in translating from the executable code domain to the hardware domain. A design that is still subject to frequent change may be implemented in executable code, because re-spinning a hardware implementation is more expensive than re-spinning a software design. A design that is stable and will be produced in large volume may be implemented in hardware (e.g., in an ASIC) because for large production runs the hardware implementation may be less expensive than software implementations. Often a design may be developed and tested in an executable code form and then later transformed, according to design rules, to an equivalent hardware implementation in an ASIC that hardwires the instructions of the executable code. In the same manner as a machine controlled by a new ASIC is a particular machine or apparatus, likewise a computer that has been programmed and/or loaded with executable instructions may be viewed as a particular machine or apparatus.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A computer-readable medium storing instructions which, when executed by a processor, cause the processor to execute an intelligent scheduling application to:
obtain activity data of a user indicating usage statistics of a computing device by the user;
analyze the activity data of the user to determine a personal score of the user;
compare the personal score of the user to a target score and scores of peers of the user to determine a comparison result;
based on the comparison result, determine a recommendation for the user; and
provide the recommendation to the user via a graphical interface.

2. The computer-readable medium of claim 1, wherein the instructions cause the processor to:
analyze calendar data of the user according to the personal score of the user to determine an analysis result; and
recommend modification of the calendar data of the user according to the analysis result.

3. The computer-readable medium of claim 2, wherein the instructions cause the processor to automatically modify the calendar data of the user according to the analysis result without intervention by the user.

4. The computer-readable medium of claim 1, wherein the instructions cause the processor to determine the personal score according to an amount of high stress time of the user as determined according to the usage statistics.

5. The computer-readable medium of claim 1, wherein the instructions cause the processor to determine the personal score according to an average stress of the user for a period of time as determined according to the usage statistics.

6. A computer-readable medium storing instructions which, when executed by a processor, cause the processor to execute an intelligent scheduling application to:
obtain activity data of a group of users;
for each user of the group of users:
determine a usage pattern based on the activity data; and
determine a personal score based on the usage pattern;
determine an average personal score for the group of users based on the personal score for each user;
compare the personal score of a user of the group of users to the average personal score to determine a comparison result; and
based on the comparison result, determine and provide a recommendation to the user.

7. The computer-readable medium of claim 6, wherein the activity data indicates an amount of time spent by the user interacting via the processor with applications.

8. The computer-readable medium of claim 7, wherein the instructions cause the processor to determine the usage pattern as an amount of stress attributable to each of the applications.

9. The computer-readable medium of claim 8, wherein the instructions cause the processor to determine the personal score as a function of the amount of stress attributable to each of the applications.

10. The computer-readable medium of claim 6, wherein the instructions cause the processor to automatically modify calendar data of the user according to the recommendation without intervention by the user.

11. A computer-readable medium storing instructions which, when executed by a processor, cause the processor to execute an intelligent scheduling application to:
capture, via the intelligent scheduling application, processor data of a computing device indicating usage statistics of a user using the computing device;
analyze the usage statistics to determine a usage pattern of the user;
analyze calendar data of the user; and
based on the usage pattern of the user and the calendar data, modify scheduling of an event included in the calendar data.

12. The computer-readable medium of claim 11, wherein the instructions cause the processor to determine the usage pattern of the user based on stress levels of the user determined according to application usage by the user indicated in the usage statistics.

13. The computer-readable medium of claim 11, wherein the instructions cause the processor to provide the user with a notification that a second event included in the calendar data is recommended for modification.

14. The computer-readable medium of claim 11, wherein the instructions cause the processor to provide the user with a notification that a period of time indicated in the calendar data is recommended for allocation as a break period.

15. The computer-readable medium of claim 11, wherein the instructions cause the processor to:
analyze calendar data of other users; and
modify scheduling of the event included in the calendar data according to the calendar data of the other users.
